(19) United States
(12) Patent Application Publication
(10) Pub. No.: US 2016/0144239 A1
(43) Pub. Date: May 26, 2016

(54) CONTROL SYSTEM FOR EXERCISE MACHINE

(71) Applicants: Adam C. Sclafani, Uniontown, OH (US); Philip K. Sclafani, Chevy Chase, MD (US)

(72) Inventors: Adam C. Sclafani, Uniontown, OH (US); Philip K. Sclafani, Chevy Chase, MD (US)

(21) Appl. No.: 14/948,568

(22) Filed: Nov. 23, 2015

Related U.S. Application Data
(60) Provisional application No. 62/082,778, filed on Nov. 21, 2014.

(51) Int. Cl. A63B 24/00; F04D 27/00; A63B 21/06; G05B 15/02

(52) U.S. Cl. CPC A63B 24/0087; G05B 15/02; F04D 27/00; A63B 21/0602; A63B 2024/0093

(57) ABSTRACT

A control system for use with an exercise machine having a first sensor for transmitting force data, a second sensor for transmitting position data, a control unit for receiving the force data and the position data and a pump activated by the control unit to add or remove liquid from a tank to increase or decrease weight resistance for the exercise machine.

### CLAIM OF PRIORITY

This application claims priority from Provisional Application Ser. No. 62/082,778 filed on Nov. 21, 2014, the entirety of which is hereby incorporated by reference.

### BACKGROUND OF THE DISCLOSURE

Most common exercise devices incorporate a stack of metal plates connected by various cable and lever mechanisms to an interface appropriate for upper body or lower body exercises. The user selects a desired amount of weight resistance by positioning a pin in the weight stack. The weight stack can vary in total amount and typically has increments of 5 lbs. or 10 lbs. of weight. Various alternative resistance modes of other exercise machines such as Bowflex® (bending of fiberglass rods), Nitroforce (compression of a pneumatic piston), Bowflex® revolution (stretching of elastic elements), etc., affect the manner in which the exercise is performed or the way it feels to the user.

Existing systems are typically non-inertial. While it is marketed as a benefit a non-inertial system is not the best mode of resistance for weight training and is largely ignored by those users who are experienced in the field.

An improvement on existing systems is to replace the weight stack in any standard style exercise machine with a weight tank and a liquid reservoir tank. The weight tank would reside in the same position as the original metal plate stack. The liquid reservoir tank would be proximal to the weight tank and remains stationary. A transferable substance (such as water or another liquid) is added or removed from the weight stack so as to provide the desired amount of weight resistance. The most basic configuration of this embodiment would include the two tanks (weight and reservoir), a pump or pumps to transfer the substance (water), a force gauge to indicate the amount of weight in the tank and a means to adjust the weight (i.e., a control panel). This is to be considered as a non-computer controlled or manual configuration. There would be an increase weight switch and a decrease weight switch as well as a numerical indicator of the present weight in the tank.

Thus, there is a need for an exercise machine with a control system which uses an adjustable tank and a computerized controller.

Other embodiments of the disclosure will be apparent upon a reading and understanding of the following detailed description.

### SUMMARY OF THE DISCLOSURE

The system relates to exercise machines. More particularly, it relates to a control system for exercise machines which uses an adjustable tank and a computerized controller.

In one embodiment of this disclosure, described is a control system for use with an exercise machine, comprising: a first sensor for transmitting force data; a second sensor for transmitting position data; a control unit for receiving the force data and the position data; and a pump activated by the control unit to add or remove liquid from a tank to increase or decrease weight resistance.

In another embodiment of this disclosure, described is a method using a control system for an exercise machine, comprising: providing an exercise machine; providing a force sensor and position sensor on the exercise machine; transmitting force data and position data to a control unit; activating the control unit using a computing unit; activating a pump via the control unit to add or remove water from a tank to control weight resistance; providing at least one radio-frequency identification sensor and transmitter to transmit the type of accessory used with said exercise machine.

One embodiment of the disclosure is a manual control system in which a ‘spotter’ or the user himself or herself could actuate the pumps during the performance of the exercise to increase or decrease the weight. This allows for many novel modalities of resistance training. It also could be configured as a safety feature wherein the user could unload the machine with a footswitch if he/she were to become too fatigued to continue and become trapped by the weight.

Another embodiment of the disclosure is the use of liquid such as water to serve as the weight in the exercise machine. Specifically, a pair of tanks and pumps replace the typical metal or rubber weight stack on an exercise machine. This allows for a control system to adjust the mass of water in response to data from the force and position sensors.

Yet another embodiment of the disclosure is from a cost standpoint, the use of water as the ‘weights’ is a cost savings over metal plates that can cost $0.50/lb. or more and are heavy and expensive to ship. Since the water is added by the end user during the setup of the machine shipping costs are also drastically reduced.

Another embodiment of the disclosure is the system allows for an infinite range of weights from 0 lbs. to the maximum capacity of the tank as opposed to the 5 or 10 lb. increments of typical existing plate loaded systems.

Another embodiment of the disclosure is it can be adapted to any of the familiar exercise machines without changing the manner in which the exercise is performed or the way it feels to the user. This is in differentiation with the various alternative resistance modes of other exercise machines such as Bowflex® (using bending of fiberglass rods), Nitroforce (using compression of a pneumatic piston), Bowflex® revolution (stretching of elastic elements), etc.

In accordance with another embodiment of the disclosure, water is supplied by an external pressurized system as in household plumbing and the device only contains a valve which is controlled by the software. The water outlet can be a passive drain that is also connected to the available plumbing.

Another embodiment of the disclosure has the water being supplied by a central reservoir and pressure system (both positive and negative), such that the individual exercise machines would only be fitted with input and output valves that interface with the positive and negative pressure water connections.

Another embodiment of the disclosure has RFID or NearField Communication identification tags that confirm which peripheral accessory is connected to the machine and where it is connected, and the accessories may contain an accelerometer or accelerometers that provide the 3D motion path of the accessory during the exercise movement.

Another embodiment of the disclosure is the disclosure utilizes a static mass with inertial resistance. In contrast, the other systems are non-inertial.

Another embodiment of the disclosure is to employ interactive software to control the exercise machine. The exercise device becomes interactive, automatic and networked. For example, the software runs on a table or smartphone and interacts with the exercise machine. The user establishes an account and registers the specific equipment and accessories that were purchased. The user inputs basic information on age, sex, training goals and experience. The software will interactively assist the user in establishing an appropriate training routine and schedule.

Still other embodiments of the disclosure will be apparent upon a reading and understanding of the following detailed disclosure.

### BRIEF DESCRIPTION OF THE DRAWINGS

FIG. 1 is a perspective view of an exercise apparatus in accordance with a preferred embodiment of the disclosure;

FIG. 2 is an enlarged partial perspective view of the pump, control unit, force sensor and position sensor in accordance with the disclosure;

FIG. 3 is an enlarged partial perspective view of a RFID sensor and lower handle in accordance with the disclosure;

FIG. 4 is an enlarged partial perspective view of a RFID sensor and upper cable connection in accordance with the disclosure; and

FIG. 5 is a flow chart illustrating the steps for using the control system.

### DETAILED DESCRIPTION OF THE DISCLOSURE

The system relates to exercise machines. More particularly, it relates to a control system for exercise machines which uses an adjustable tank and a computerized controller.

The basic control system of the present disclosure includes water tanks, a force/weight sensor and pumps. It is manually controlled by the user to increase or decrease the weight in the tank. With the addition of a position sensor and a microcontroller, many additional features become possible. The control system has a user interface that activates the various control programs.

Specifically, a position sensor 26 can be added to an exercise machine to report data on the motion of the weight tank. This can be used to assess the range of motion, velocity (average and max), acceleration (average and max) of the weight tank and be translated into user performance data. A force sensor 24 is used to assess the amount of force exerted to move the weight and the position sensor 26 can feed data to a microcontroller that has preprogrammed modes of control dependent upon the data feed from the sensors.

Another aspect of the disclosure is that the system of sensors 24, 26 and control unit 28 are operated by a separate (or integral) networked computing device may be configured in various exercise devices for other than the one shown.

Position sensor 26 reports movement of the load tank 32 which enables the display of range of motion, velocity and acceleration of the resistance load. Metrics besides the traditional weight can be training targets such as speed of contraction with feedback on maximums and level of improvement.

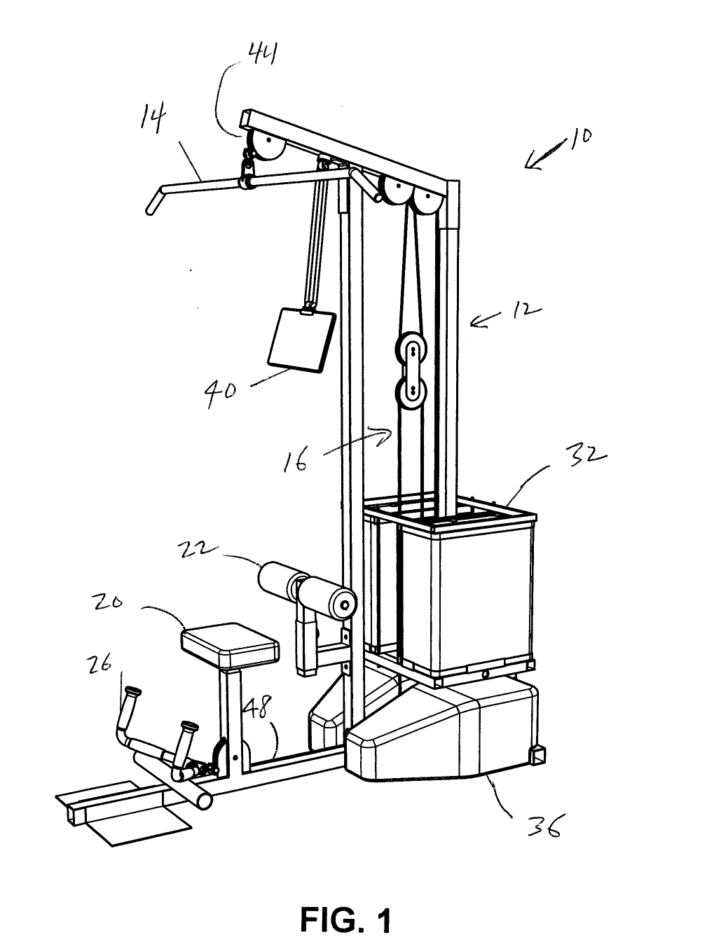

Specifically, referring now to FIGS. 1-4, an embodiment of the disclosure in accordance with a preferred embodiment is shown. System 10 is shown with a lat cable tension machine 12 for pulling downwardly or laterally. As with existing cable machines, the cable machine includes an upper lateral handle 14 attached to an upper end of a cable 16 and a lower lateral handle 18 connected to a lower end of cable 16.

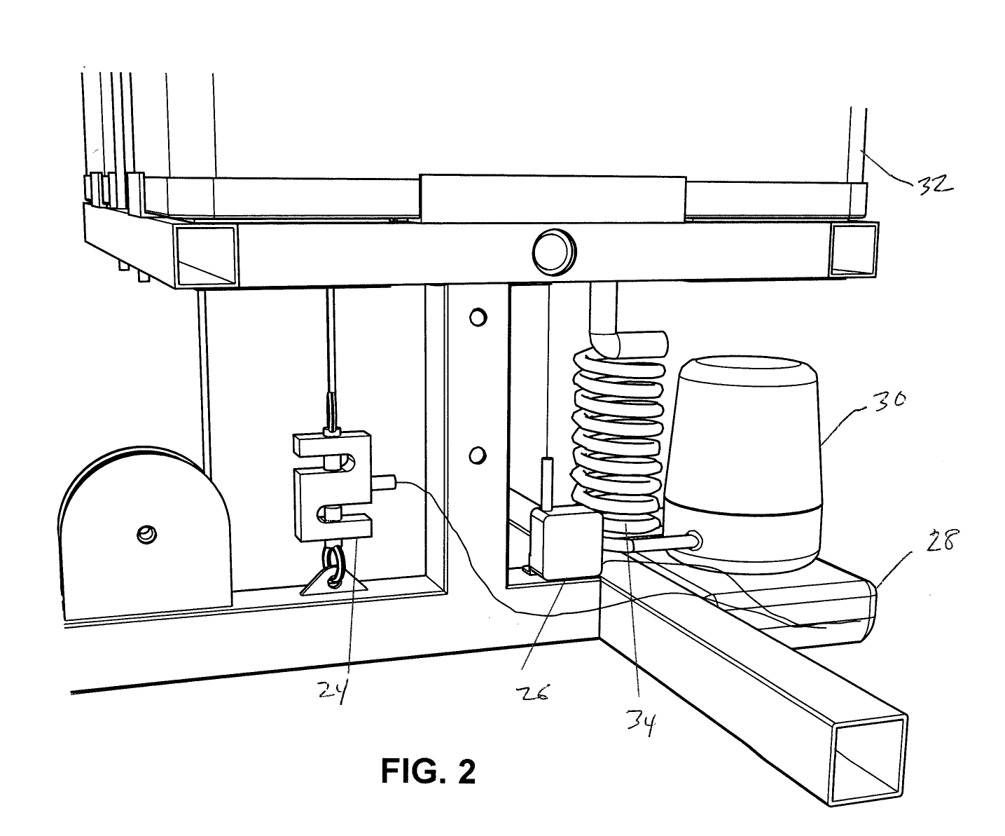

An adjustable seat 20 and adjustable leg support 22 are provided for the user to be seated during the lateral or pull down exercises. Referring to FIG. 2, a force sensor 24 and a position sensor 26 report or transmit force data and position data to a control unit 28. Respectively, the position data and force data then are processed according to various software functions resulting in the control unit 28 activating a pump 30 to either add water to a load tank assembly 32 or remove water from the load tank assembly 32 via a coiled fluid transfer hose 34. Water is added to increase resistance or removed to decrease resistance. A reservoir of water is provided in a reservoir tank assembly 36.

Water is preferably used as the mass providing inertial resistance. Water is a controllable variable and provides inertial resistance. Pump or pumps 30 will move water in and out of the load tank 32. This allows for a continuous range of variable resistance. A user can select resistance from 0-Max lbs. in a continuous range. Load cell(s) will measure the force of gravity on the load tank which provides a means for determination of level of resistance (weight). A display or indicator shows the load cell data and displays the amount of weight loaded. A control actuator (e.g., dial, switch, etc.) operates the pump or pumps as a means for the user to raise or lower the amount of weight in the tank. Foot pedals can be added to control weight during exercise which will permit the user to adjust resistance “on the fly”.

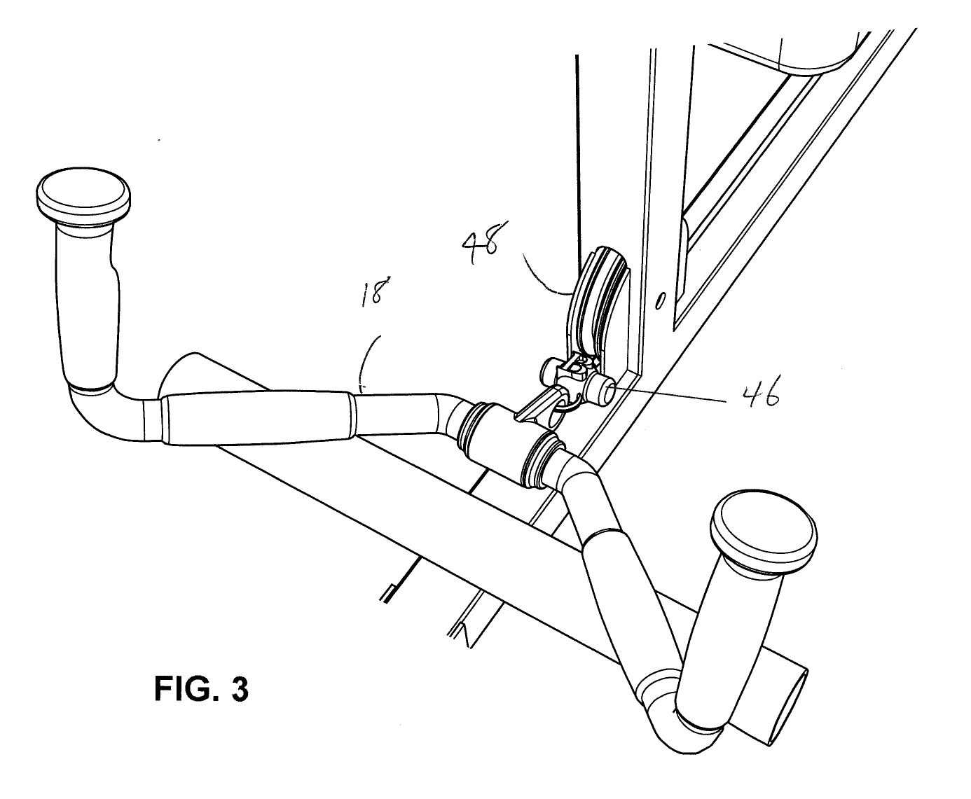

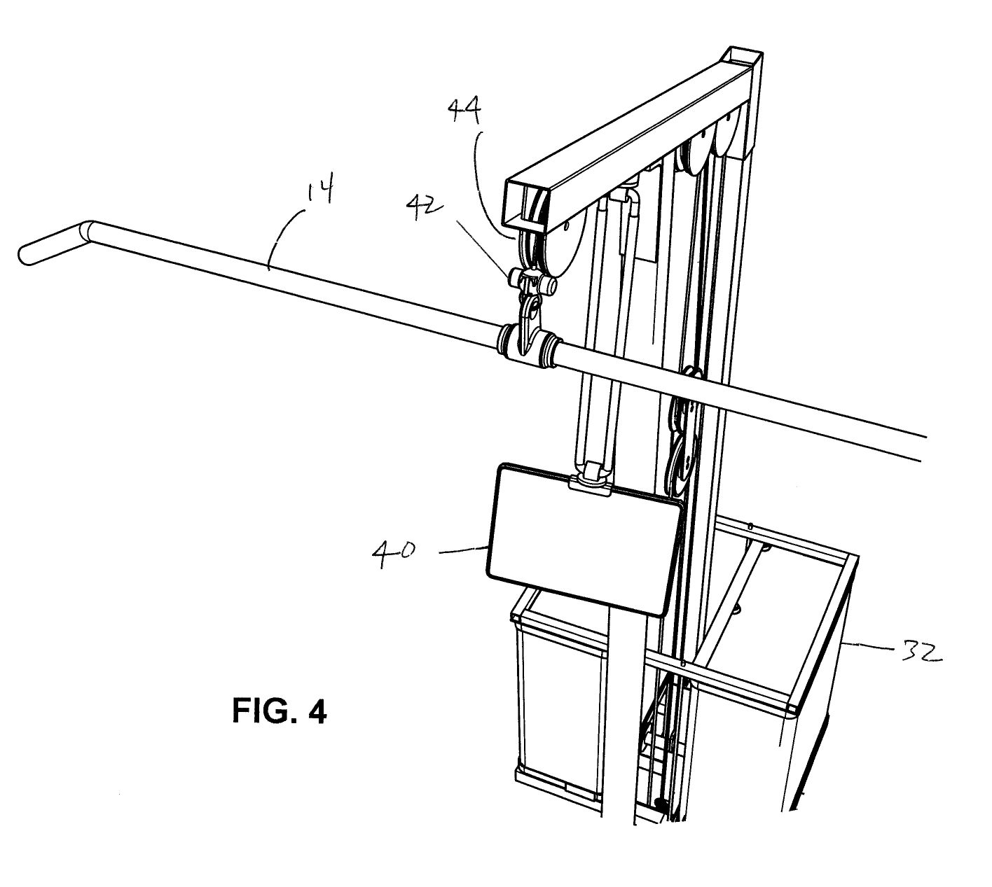

Referring now to FIG. 4, the initiation and monitoring of the control unit function are provided by a network enabled computing device 40. For example, the computing device 40 can be a network enabled computer, laptop, tablet, smartphone, or any other suitable computing device. A Radio-frequency identification (RFID) sensor and transmitter 42 connected to an upper cable connector 44 and an RFID sensor and transmitter 46 (FIG. 3) connected to a lower cable connector 48 report to the control unit 28 the specific type of accessory that is attached. This information in turn is relayed to the network enabled computing device 40.

Upper handle 14 is attached to the upper cable connector 44 while a lower handle 18 is attached to a lower cable connector 48. An additional seat may be provided for use with the handle 18 to perform lateral rowing.

It is intended that the network enabled computing device 40 will communicate with the control unit via a wireless connection and run various software applications that the user may download via the internet.

There may be two pumps 30 or more. There may also be valves. The substance that is transferred may be water or any transferrable mass (i.e., liquid, slurry, powder, etc.). The critical differentiator is the property of inertial mass that is controlled at any time during the use of the device.

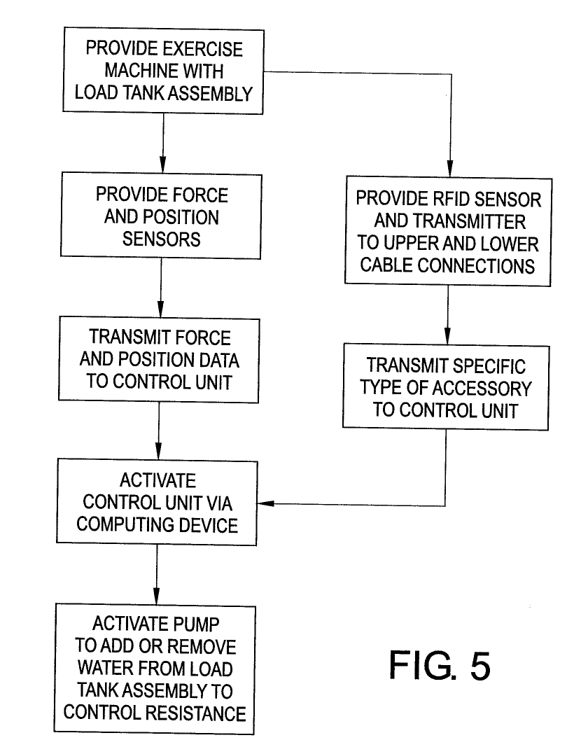

A method of using the system according to an embodiment of the disclosure is shown in the flow chart of FIG. 5 and is discussed below. First, an exercise machine is provided having upper and lower handles for performing lateral or pull-down exercises. A force sensor 24 and position sensor 26 are provided to transmit force and position data to a control unit 28. The control unit is monitored and activated using a network enabled computing device. The control unit receives the force data and position data and activates a pump to add or remove water from a load tank assembly via a coiled fluid transfer hose.

An RFID sensor and transmitter for an upper cable connector and an RFID sensor and transmitter for a lower cable connector transmit to the control unit the specific type of accessory used with the machine. The control unit in turn transmits the information to the network enabled computer device. The pump(s) is activated to add or remove water from a load tank assembly to control weight resistance.

In accordance with another embodiment of the disclosure, manual loading of metal plates is also contemplated by the disclosure. That is, the computing device 40 will prompt the user to add the appropriate weight to the system. The system will track the performance data using the sensors data collection and processing in the control unit.

According to another aspect of the disclosure, the water is supplied by a central reservoir and pressure system (both positive and negative), such that the individual exercise machines would only be fitted with input and output valves that interface with the positive and negative pressure water connections.

In addition to the described RFID or NearField Communication identification tags that would confirm which peripheral accessory is connected to the machine and where it is connected, accessories may also contain an accelerometer or accelerometers that provide the 3D motion path of the accessory during the exercise movement.

The control of the device may be remotely actuated as in a remote physical therapy session. This may additionally incorporate the use of a web cam or voice over IP type two way communication.

The device may also be fitted with a biosensor identification device for user identity verification.

One aspect of the disclosure is to provide training modalities that track performance metrics other than the traditional weight of the resistance load. For example, a user may wish to exercise with a specific total work load goal. The sensors could calculate the total work performed and inform the use of his/her performance. Acceleration and velocity may also be tracked as performance metrics. The device may be programmed to adjust the resistance load during an exercise if the acceleration/velocity parameters are not maintained.

It is intended that the software applications would allow the user to set up (or download) a workout routine. The workout routine would be loaded into the app. The app would guide the user through the routine, set up the resistance levels, record the performance metrics and assist by adjusting resistance if necessary.

Another aspect of the disclosure is that the user may have an account on the internet that stores performance data. This account may be accessed at other locations and used to control similar devices (for example, hotels, gyms, health clubs, physical therapy clinics, etc.). Any data collected at these locations would then be uploaded to the user's account.

Another aspect of the disclosure is that the performance data from workouts may be streamed on the internet or posed to social media.

A display shows values for range of motion, velocity and acceleration. This offers a set of new metrics for training routine aside from the traditional resistance level metric.

An onboard microprocessor/computer calculates the performance levels from position to force data and records and displays performance to user interface (i.e., screen).

A software control of microprocessor/computer provides new exercise modes where the microprocessor controls the resistance in response to force and motion data from sensors. These are “workout modes” so the computer can help the user while the user works out for example by lowering the resistance as the user shows fatigue. Data storage (built-in or removable) allows for the collection of historical performance data. Thus, the user can keep track of their “workout history”, i.e., performance levels, date/time, specific exercises performed, etc.

An attachment/accessory sensor enables the machine to detect what type of accessory has been attached and where it is attached. On a lat machine configuration, for example, the computer will sense what type of handle 14, 18 has been attached to either the upper or lower cable 44, 48. The computer can then determine if the handle is appropriate for the intended movement. The computer can also record which accessory is used. A network interface for onboard computer allows for internet or network access of machine by other users and the uploading or downloading of programs and data. Remote users can monitor and adjust machine parameters, remote physical therapy users can download new workout programs, etc.

After the exercise routing is specified, the software will activate and control the exercise device so as to set and control the resistance, record the performance, time the duration between each exercise. Upon completion of the workout, the data is recorded and uploaded to the user's account and will be used for progress reports and other training and coaching advice. The software becomes a training partner, a coach, and a trainer by helping the user set up their workouts, assisting (spotting) during the workouts, and analyzing their continued performance through the collected data. The user interface of the software will have options for viewing videos on proper form and technique. Performance metrics will be displayed in realtime as well as be recorded so the user can assess their performance and progress quantitatively. Workout data could be shared on Facebook or Twitter directly from the software interface.

A touch screen display provides the interface for controlling the system and viewing performance history.

Online content (subscription) allows the networked exercise machine to download a variety of content, pre-programmed workout routines, educational videos, etc.

Social media access allows users to post/trade workouts and compare performance with other users.

The microcontroller would turn on or off the appropriate pump to add or remove weight from the weight tank based on the user mode selected.

In basic operation the user inputs the desired weight and the microcontroller would control the pumps so as to adjust the water level until it matches the input amount.

A motion sensor could be used to count reps and report when the user is showing signs of fatigue thereby reducing the weights automatically.

Preprogrammed modes could vary the weight in predetermined patterns or in response to force and position data.

One aspect of the disclosure is the user merely enters a number on a touch pad to set the weight eliminating the loading and unloading of plates or positioning of a pin or other configuration changes that may be required.

Another aspect of the disclosure is weight selections available are on continuous range without incrementation.

Still another aspect of the disclosure is sensors can be used to assess performance metrics that are not available on currently available machines.

Another aspect of the disclosure is users can train for maximum acceleration, total work performed, maximum velocity, sustained velocity, and other metrics.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the disclosure and appended claims or the equivalents thereof.

1. A control system for use with an exercise machine, comprising:
a first sensor for transmitting force data;
a second sensor for transmitting position data;
a control unit for receiving said force data and said position data;
a pump activated by said control unit to add or remove liquid from a first tank to increase or decrease resistance.

2. The control system of claim 1, further comprising a hose to transfer liquid to and from said first tank.

3. The control system of claim 1, further comprising a second tank for storing a reservoir of liquid.

4. The control system of claim 1, further comprising a computing device to initiate and monitor said control unit.

5. The control system of claim 1, wherein said liquid is water.

6. The control system of claim 4, wherein said computing device is a network enabled computer.

7. The control system of claim 1, further comprising a first radio-frequency identification sensor and transmitter connected to an upper portion of said exercise machine.

8. The control system of claim 7, further comprising a second radio-frequency identification sensor and transmitter connected to a lower portion of said exercise machine.

9. The control system of claim 2, wherein said hose is a coiled fluid transfer hose.

10. The control system of claim 8, wherein said first and second radio-frequency identification sensor and transmitter transmit to said control unit a specific accessory attached to said exercise machine.

11. The control system of claim 7, wherein said radio-frequency identification sensor and transmitter are connected to an upper cable connector on said exercise machine.

12. The control system of claim 8, wherein said second radio-frequency identification sensor and transmitter are connected to a lower cable connector on said exercise machine.

13. A method using a control system for an exercise machine, comprising:
providing an exercise machine;
providing a force sensor and position sensor on said exercise machine;
transmitting force data and position data via said force sensor and said position sensor to a control unit;
activating said control unit using a computing unit;
activating a pump via said control unit to add or remove water from a first tank to control weight resistance;
providing at least one radio-frequency identification sensor and transmitter to transmit the type of accessory used with said exercise machine.

14. The control system of claim 13, further comprising a hose to transfer liquid to and from said first tank.

15. The control system of claim 13, further comprising a second reservoir tank for storing a reservoir of liquid.

16. The control system of claim 13, wherein said computing device is a network enabled computer.

17. The control system of claim 13, wherein said hose is a coiled fluid transfer hose.
